(19) United States
(12) Patent Application Publication
(10) Pub. No.: US 2016/0266519 A1
(43) Pub. Date: Sep. 15, 2016

(54) DEVELOPING DEVICE AND IMAGE FORMING APPARATUS

(71) Applicant: FUJI XEROX CO., LTD., Tokyo (JP)

(72) Inventors: Shinji OKUYAMA, Kanagawa (JP); Yasuaki WATANABE, Kanagawa (JP); Jun ABE, Kanagawa (JP); Tomoyuki YOSHII, Kanagawa (JP); Toshihiro KANEMATSU, Kanagawa (JP); Takashi OCHI, Kanagawa (JP); Kenta URAYAMA, Kanagawa (JP); Fumiyuki HONDA, Kanagawa (JP)

(73) Assignee: FUJI XEROX CO., LTD., Tokyo (JP)

(21) Appl. No.: 14/850,489

(22) Filed: Sep. 10, 2015

(30) Foreign Application Priority Data
Mar. 11, 2015 (JP) 2015-048826

(51) Int. Cl. G03G 15/09

(52) U.S. Cl. CPC G03G 15/0921

(57) ABSTRACT

A developing device includes a container in which developer is contained; and a developer carrier disposed in the container, the developer carrier including a magnet member having magnetic poles, and a rotation member that covers an outer circumference of the magnet member and is rotatably supported, the developer carrier developing a latent image formed on an image carrier into a visible image with the developer held on a surface of the rotation member as an effect of the magnet member. The rotation member has projections and recesses formed in the surface, which satisfy y≧1.875×x+11.25, where y is an average depth of the projections and recesses when a lowest position of the recesses is assumed to be 0 and a highest position of the projections is assumed to be 100, and x is a ten-point average roughness of the projections and recesses.

### CROSS-REFERENCE TO RELATED APPLICATIONS

This application is based on and claims priority under 35 USC 119 from Japanese Patent Application No. 2015-048826 filed Mar. 11, 2015.

### BACKGROUND

### Technical Field

The present invention relates to a developing device and an image forming apparatus.

### SUMMARY

According to an aspect of the present invention, there is provided a developing device including a container in which developer is contained; and a developer carrier disposed in the container, the developer carrier including a magnet member having multiple magnetic poles and including a rotation member that covers an outer circumference of the magnet member and is supported in a rotatable manner, the developer carrier developing a latent image formed on an image carrier into a visible image with the developer held on a surface of the rotation member as an effect of the magnet member. The rotation member has projections and recesses formed in the surface, the projections and recesses satisfying

y≧1.875×x+11.25 Expression (1),

where y is an average depth of the projections and recesses when a lowest position of the recesses is assumed to be 0 and a highest position of the projections is assumed to be 100, and x is a ten-point average roughness of the projections and recesses.

### BRIEF DESCRIPTION OF THE DRAWINGS

Exemplary embodiments of the present invention will be described in detail based on the following figures, wherein:

FIG. 1 is a diagram for explaining an image forming apparatus according to a first exemplary embodiment;

FIG. 2 is a diagram for explaining a relevant part of the image forming apparatus according to the first exemplary embodiment;

FIG. 3 is a diagram for explaining a developing device according to the first exemplary embodiment;

FIG. 4 is a sectional view taken along line IV-IV in FIG. 3;

FIGS. 5A and 5B are diagrams for explaining projections and recesses in the surface of a developing sleeve according to the exemplary embodiment, wherein FIG. 5A shows a case where duty is small, and FIG. 5B shows a case where duty is large.

FIG. 6 shows a gap between a photoconductor and the surface of a developing roller.

FIG. 7 is a table of Examples and Comparison Examples.

FIGS. 8A to 8C show results of experiments, wherein FIG. 8A is a graph in which Rz is plotted on the horizontal axis, and duty is plotted on the vertical axis; FIG. 8B is a graph in which Rz is plotted on the horizontal axis, and the development capability is plotted on the vertical axis; and FIG. 8C is a graph in which duty is plotted on the horizontal axis, and the development capability is plotted on the vertical axis.

### DETAILED DESCRIPTION

Referring to the drawings, exemplary embodiments of the present invention will be described below. Note that the present invention is not limited to the following exemplary embodiments.

For ease of understanding the following description, in the drawings, the front-rear direction will be referred to as X-axis direction, the left-right direction will be referred to as Y-axis direction, and the top-bottom direction will be referred to as Z-axis direction. The directions or sides indicated by arrows X, −X, Y, −Y, Z, and −Z correspond to the front, rear, right, left, top, and bottom directions or sides, respectively.

Furthermore, in the drawings, a sign or a symbol formed of a circle and a dot (a dot is encircled by a circle) represents an arrow extending from the rear surface to the front surface of the sheet, and a sign or a symbol formed of a circle and a cross (a cross is encircled by a circle) represents an arrow extending from the front surface to the rear surface of the sheet.

For ease of understanding, members that need not be described in the following description are not shown in the drawings.

### First Exemplary Embodiment

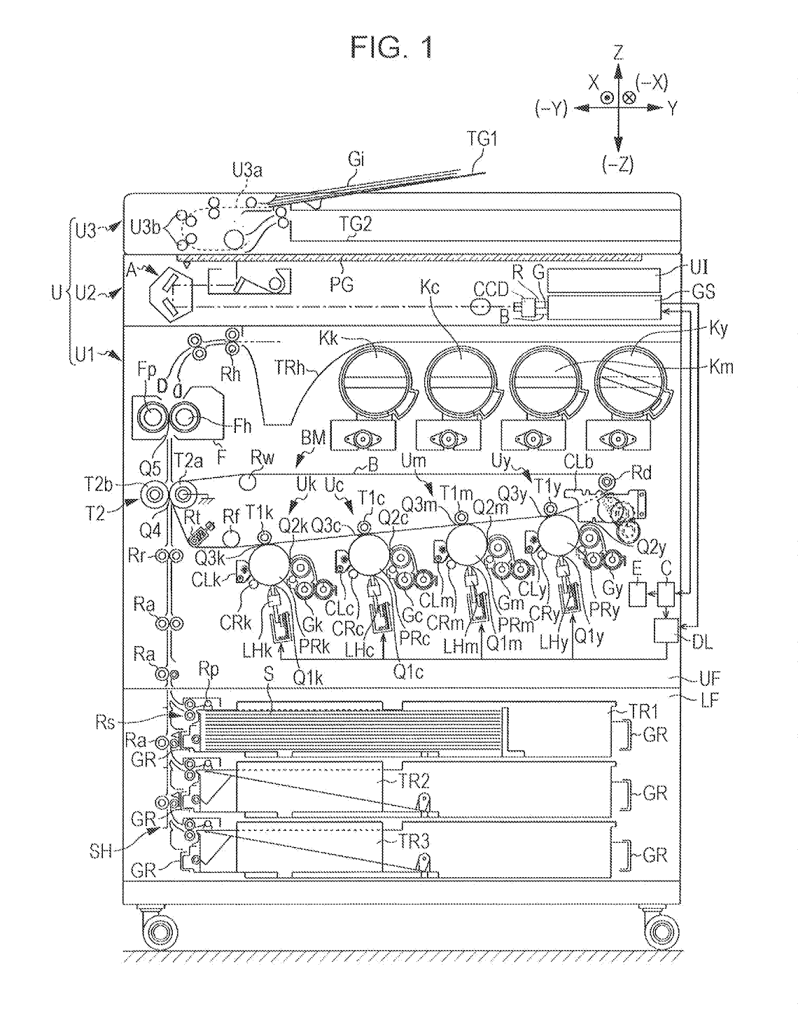

FIG. 1 is a diagram for explaining an image forming apparatus according to a first exemplary embodiment.

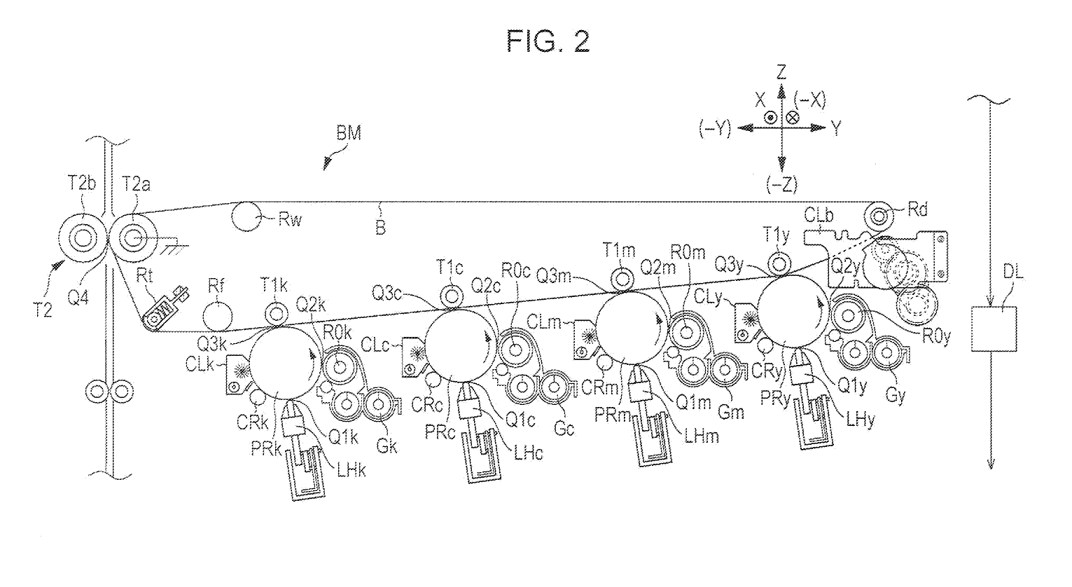

FIG. 2 is a diagram for explaining a relevant part of the image forming apparatus according to the first exemplary embodiment.

In FIG. 1, a copier U, serving as an example of an image forming apparatus according to the first exemplary embodiment of the present invention, includes a printer portion U1, serving as an example of a recording unit and an example of an image recording device. The printer portion U1 supports a scanner portion U2 disposed thereon, which serves as an example of a reading unit and an example of an image reading device. The scanner portion U2 supports an automatic feeder U3 disposed thereon, which serves as an example of a document transport device. The scanner portion U2 according to the first exemplary embodiment supports a user interface UI, serving as an example of an input portion. The user interface UI allows an operator to input a command to control the copier U.

A document tray TG1, serving as an example of a medium accommodating container, is disposed on the automatic feeder U3. The document tray TG1 holds a stack of documents Gi to be copied. A document output tray TG2, serving as an example of a document output portion, is formed below the document tray TG1. Document transport rollers U3b are disposed between the document tray TG1 and the document output tray TG2, along a document transport path U3a.

A platen glass PG, serving as an example of a transparent document bed, is disposed in the top surface of the scanner portion U2. In the scanner portion U2 according to the first exemplary embodiment, a reading optical system A is disposed below the platen glass PG. The reading optical system A according to the first exemplary embodiment is supported so as to be able to move in the left-right direction, along the lower surface of the platen glass PG. The reading optical system A is normally stationary at an initial position shown in FIG. 1.

An imaging device CCD, serving as an example of an imaging member, is disposed to the right of the reading optical system A. An image processing portion GS is electrically connected to the imaging device CCD.

The image processing portion GS is electrically connected to a writing circuit DL of the printer portion U1. The writing circuit DL is electrically connected to LED heads LHy, LHm, LHc, and LHk, serving as an example of a latent image forming device.

Photoconductor drums PRy, PRm, PRc, and PRk, serving as an example of an image carrier, are disposed above the LED heads LHy to LHk.

Charging rollers CRy, CRm, CRc, and CRk, serving as an example of a charger, are disposed so as to face the photoconductor drums PRy to PRk. A power supply circuit E applies a charging voltage to the charging rollers CRy to CRk. The power supply circuit E is controlled by a controller C, serving as an example of a controller. The controller C transmits signals to and receives signals from the image processing portion GS, the writing circuit DL, etc. to perform various types of control.

The LED heads LHy to LHk radiate writing light to the surfaces of the photoconductor drums PRy to PRk, more specifically, to writing areas Q1y, Q1m, Q1c, and Q1k designated on the downstream side of the charging rollers CRy to CRk in the rotation direction of the photoconductor drums PRy to PRk.

In developing areas Q2y, Q2m, Q2c, and Q2k designated on the downstream side of the writing areas Q1y to Q1k, in the rotation direction of the photoconductor drums PRy to PRk, developing devices Gy, Gm, Gc, and Gk are disposed so as to face the surfaces of the photoconductor drums PRy to PRk.

First transfer areas Q3y, Q3m, Q3c, and Q3k are designated on the downstream side of the developing areas Q2y to Q2k in the rotation direction of the photoconductor drums PRy to PRk. The photoconductor drums PRy to PRk are in contact with an intermediate transfer belt B, serving as an example of an intermediate transfer body, in the first transfer areas Q3y to Q3k. Furthermore, in the first transfer areas Q3y, Q3m, Q3c, and Q3k, first transfer rollers T1y, T1m, T1c, and T1k, serving as an example of a first transfer member, are disposed so as to face the photoconductor drums PRy to PRk, with the intermediate transfer belt B therebetween.

Drum cleaners CLy, CLm, CLc, and CLk, serving as an example of an image-carrier cleaner, are disposed on the downstream side of the first transfer areas Q3y to Q3k, in the rotation direction of the photoconductor drums PRy to PRk.

A belt module BM, serving as an example of an intermediate transfer device, is disposed above the photoconductor drums PRy to PRk. The belt module BM includes the intermediate transfer belt B. The intermediate transfer belt B is supported, in a rotatable manner, by a driving roller Rd, serving as an example of a driving member; a tension roller Rt, serving as an example of a tension member; a walking roller Rw, serving as an example of a meandering correcting member; an idler roller Rf, serving as an example of a driven member; a back-up roller T2a, serving as an example of an opposing member in a second transfer area; and the first transfer rollers T1y, T1m, T1c, and T1k.

A second transfer roller T2b, serving as an example of a second transfer member, is disposed so as to face the back-up roller T2a with the intermediate transfer belt B therebetween. The back-up roller T2a and the second transfer roller T2b together form a second transfer member T2. Furthermore, a second transfer area Q4 is formed at an area where the second transfer roller T2b and the intermediate transfer belt B face each other.

The first transfer rollers T1y to T1k, the intermediate transfer belt B, and the second transfer member T2 together, and the likes form a transfer device T1+T2+B according to the first exemplary embodiment, which transfers images formed on the photoconductor drums PRy to PRk to a medium.

A belt cleaner CLb, serving as an example of an intermediate-transfer-body cleaner, is disposed on the downstream side of the second transfer area Q4 in the rotation direction of the intermediate transfer belt B.

Cartridges Ky, Km, Kc, and Kk, serving as an example of a developer accommodating container, are disposed above the belt module BM. The cartridges Ky to Kk store developer to be supplied to the developing devices Gy to Gk. The cartridges Ky to Kk and the developing devices Gy to Gk are connected to each other via developer supply devices (not shown).

Paper feed trays TR1 to TR3, serving as an example of a medium accommodating container, are disposed below the printer portion U1. The paper feed trays TR1 to TR3 are supported by guide rails GR, serving as an example of a guide member, such that they may be attached to or removed from the printer portion U1 in the front-rear direction. The paper feed trays TR1 to TR3 accommodate sheets S, serving as an example of media.

A pick-up roller Rp, serving as an example of a medium pick-up member, is disposed to the upper left of each of the paper feed trays TR1 to TR3. A separating roller Rs, serving as an example of a separating member, is disposed to the left of the pick-up roller Rp.

A medium transport path SH extending upward is formed to the left of the paper feed trays TR1 to TR3. Multiple transport rollers Ra, serving as an example of a medium transport member, are disposed along the transport path SH. A register roller Rr, serving as an example of a feeding member, is disposed in the transport path SH, at a position on the downstream side in the sheet-transport direction and on the upstream side of the second transfer area Q4.

A fixing device F is disposed above the second transfer area Q4. The fixing device F includes a heating roller Fh, serving as an example of a heating member, and a pressure roller Fp, serving as an example of a pressure member. A contact area between the heating roller Fh and the pressure roller Fp constitutes a fixing area Q5.

A discharge roller Rh, serving as an example of a medium transport member, is disposed on the diagonally upper side of the fixing device F. An output tray TRh, serving as an example of a medium output portion, is formed to the right of the discharge roller Rh.

Image Forming Operation

Multiple documents Gi stored on the document tray TG1 sequentially pass through a document reading position on the platen glass PG and are discharged onto the document output tray TG2.

When a copying operation is performed using the automatic feeder U3 that automatically transports the documents, the documents Gi sequentially passing through the reading position on the platen glass PG are exposed to light by the reading optical system A stationarily disposed at an initial position.

When a copying operation is performed by an operator who places the documents Gi on the platen glass PG by hand, the document on the platen glass PG is scanned, while being exposed to the light, by the reading optical system A moving in the left-right direction.

The reflected light from the document Gi passes through the reading optical system A and is collected by the imaging device CCD. The imaging device CCD converts the reflected light from the document Gi, collected on an imaging surface thereof, into electric signals corresponding to red (R), green (G), and blue (B).

The image processing portion GS converts the RGB electric signals, input from the imaging device CCD, into image information corresponding to black (K), yellow (Y), magenta (M), and cyan (C) and temporarily stores the information. The image processing portion GS then outputs the temporarily stored image information to the writing circuit DL at predetermined timing, so that the image information is used to form latent images.

When an original image is a single-color image, i.e., a monochrome image, image information corresponding to only black (K) is input to the writing circuit DL.

The writing circuit DL has driving circuits (not shown) for Y, M, C, and K and outputs signals corresponding to the image information inputted thereto to the LED heads LHy to LHk for the respective colors at predetermined timing.

The surfaces of the photoconductor drums PRy to PRk are charged by the charging rollers CRy to CRk. The LED heads LHy to LHk form electrostatic latent images on the surfaces of the photoconductor drums PRy to PRk in the writing areas Q1y to Q1k. The developing devices Gy to Gk develop the electrostatic latent images on the surfaces of the photoconductor drums PRy to PRk into toner images, serving as an example of a visible image, in the developing areas Q2y to Q2k. When the developing devices Gy to Gk consume the developer, the cartridges Ky to Kk supply the developer to the developing devices Gy to Gk, according to the amount consumed.

The toner images on the surfaces of the photoconductor drums PRy to PRk are transported to the first transfer areas Q3y, Q3m, Q3c, and Q3k. A first transfer voltage having the opposite polarity to the toner is applied from a power supply circuit E to the first transfer rollers T1y to T1k at predetermined timing. As a result, the toner images on the photoconductor drums PRy to PRk are sequentially transferred, in a superposed manner, to the intermediate transfer belt B in the first transfer areas Q3y to Q3k as an effect of the first transfer voltage. Note that, when a monochrome image of black is to be formed, only a black toner image is transferred from the photoconductor drum PRk to the intermediate transfer belt B.

The toner images on the photoconductor drums PRy to PRk are first-transferred to the intermediate transfer belt B, serving as an example of an intermediate transfer body, by the first transfer rollers T1y, T1m, T1c, and T1k. Residues and deposits remaining on the surfaces of the photoconductor drums PRy to PRk after the first transfer are cleaned by the photoconductor cleaners CLy to CLk. The cleaned surfaces of the photoconductor drums PRy to PRk are charged again by the charging rollers CRy to CRk.

A sheet S stored in the paper feed tray TR1, TR2, or TR3 is picked up by the pick-up roller Rp at predetermined paper feed timing. When the pick-up roller Rp picks up several sheets S at a time, the separating roller Rs separates the sheets S into individual sheets S. The sheet S having passed through the separating roller Rs is transported to the register roller Rr by the multiple transport rollers Ra.

The register roller Rr feeds the sheet S in accordance with the timing at which the toner image on the surface of the intermediate transfer belt B is transported to the second transfer area Q4.

When the sheet S fed by the register roller Rr passes through the second transfer area Q4, the toner image on the surface of the intermediate transfer belt B is transferred the sheet S, as an effect of a second transfer voltage applied to the second transfer roller T2b.

The surface of the intermediate transfer belt B after passing through the second transfer area Q4 is cleaned by the belt cleaner CLb to remove the residual toner.

The sheet S having passed through the second transfer area Q4 is heated and pressed by the fixing device F as it passes through the fixing area Q5. Thus, the toner image on the sheet S is fixed to the sheet S.

The recording sheet S to which the toner image has been fixed is discharged onto the output tray TRh by the discharge roller Rh.

Developing Device

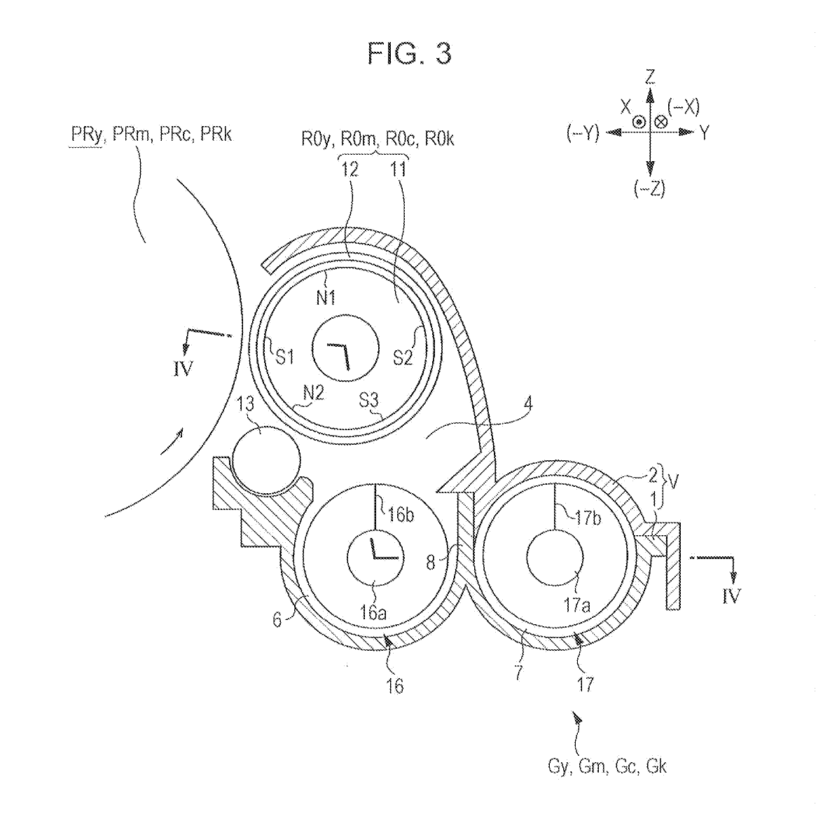

FIG. 3 is a diagram for explaining the developing device according to the first exemplary embodiment.

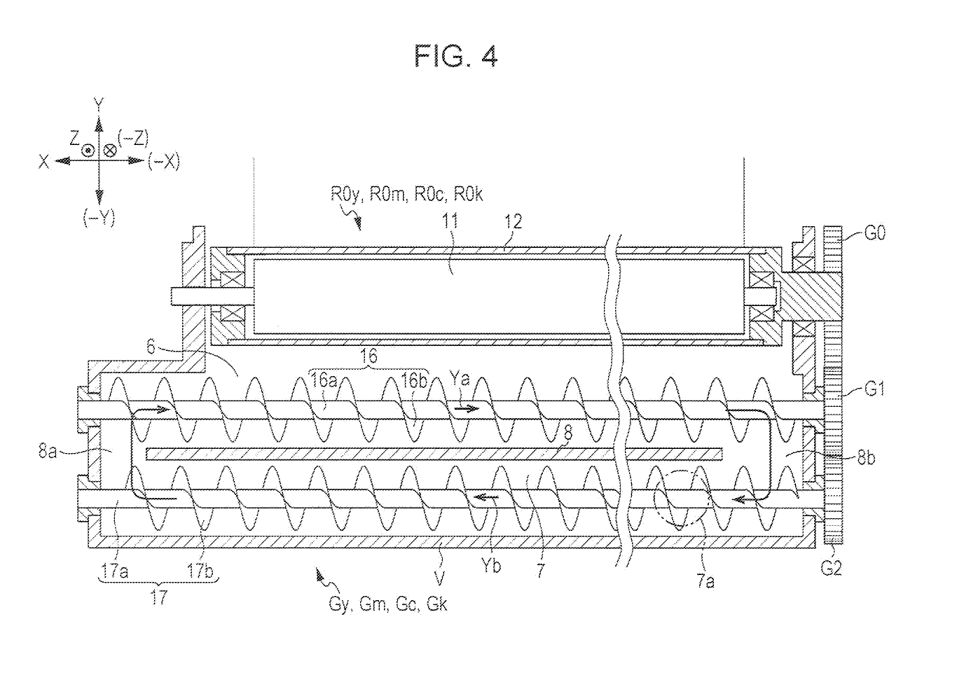

FIG. 4 is a sectional view taken along line IV-IV in FIG. 3.

Next, the developing devices Gy, Gm, Gc, and Gk according to the first exemplary embodiment of the present invention will be described. Because the developing devices Gy, Gm, Gc, and Gk for the respective colors have the same configuration, only the developing device Gy for yellow (Y) will be described in detail below, while omitting a detailed description of the developing devices Gm, Gc, and Gk for the other colors.

In FIGS. 3 and 4, the developing device Gy disposed so as to face the photoconductor drum PRy includes a developer container V that stores two-component developer composed of toner and carrier. In FIG. 3, the developer container V includes a container body 1 constituting a lower part of the developer container V. The container body 1 supports a container cover 2, serving as an example of a lid member, provided thereon. The container cover 2 closes the top surface of the container body 1.

In FIGS. 3 and 4, the container body 1 has a developing roller chamber 4, serving as an example of a developer-carrier accommodating portion, formed at the upper left part thereof. A supply chamber 6, serving as an example of a first accommodating chamber, is formed below the developing roller chamber 4. The supply chamber 6 and the developing roller chamber 4 are connected to each other. A stirring chamber 7, serving as an example of a second accommodating chamber, is formed to the right of the supply chamber 6.

The supply chamber 6 and the stirring chamber 7 are separated from each other by a partition wall 8, serving as an example of a partition member. In FIG. 4, a first inflow portion 8a, serving as an example of a first connecting portion and connecting between the supply chamber 6 and the stirring chamber 7, is formed in front of the partition wall 8. In the first exemplary embodiment, the first inflow portion 8a is disposed in front of the front end of the developing roller chamber 4. Furthermore, a second inflow portion 8b, serving as an example of a second connecting portion and connecting between the supply chamber 6 and the stirring chamber 7, is formed behind the partition wall 8.

The developing roller chamber 4 accommodates a developing roller R0y, serving as an example of a developer carrier. The developing roller R0y is disposed such that an upper left portion of the outer surface thereof faces the photoconductor drum PRy. The developing roller R0y includes a magnet roller 11, serving as an example of a magnet member. In FIG. 4, the magnet roller 11 is supported by the developer container V in a non-rotatable manner. In FIGS. 3 and 4, a developing sleeve 12, serving as an example of a rotation member, is disposed around the magnet roller 11. The developing sleeve 12 is supported by the developer container V so as to be rotatable. A gear G0, serving as an example of a driving-force transmission member, is supported at the rear end of the developing sleeve 12. A motor (not shown), serving as an example of a driving force source, transmits a driving force to the gear G0. In the developing device Gy according to the first exemplary embodiment, when a driving force from the motor is transmitted, the developing sleeve 12 rotates in the same direction as the surface of the photoconductor drum PRy, in the developing area Q2y.

A trimmer 13, serving as an example of a layer-thickness restriction member, is disposed below the developing roller chamber 4. The trimmer 13 according to the first exemplary embodiment has a cylindrical shape extending in the front-rear direction. The trimmer 13 is supported at a predetermined distance from the developing sleeve 12, in a non-rotatable manner.

The magnet roller 11 has a developing magnetic pole S1 corresponding to the developing area Q2y. The magnet roller 11 also has a trimming magnetic pole N2, serving as an example of a layer-thickness restricting magnetic pole, at a position facing the trimmer 13. The trimming magnetic pole N2 has the opposite polarity to the developing magnetic pole S1. Furthermore, a transport magnetic pole N1 having the opposite polarity to the developing magnetic pole S1 is provided on the downstream side of the developing magnetic pole S1 in the rotation direction of the developing sleeve 12. A pick-off magnetic pole S2, serving as an example of developer-detaching magnetic pole, is provided on the downstream side of the transport magnetic pole N1 in the rotation direction of the developing sleeve 12. The pick-off magnetic pole S2 has the opposite polarity to the transport magnetic pole N1. A pick-up magnetic pole S3, serving as an example of a developer pick-up magnetic pole, is provided on the downstream side of the pick-off magnetic pole S2 and on the upstream side of the trimming magnetic pole N2 in the rotation direction of the developing sleeve 12. The pick-up magnetic pole S3 has the same polarity as the pick-off magnetic pole S2 and the opposite polarity to the trimming magnetic pole N2.

In FIGS. 3 and 4, a supply auger 16, serving as an example of a first transport member, is disposed in the supply chamber 6. The supply auger 16 includes a rotation shaft 16a extending in the front-rear direction. The rotation shaft 16a supports a spiral transport blade 16b on the outer circumference thereof. Furthermore, the rotation shaft 16a supports a gear G1, serving as an example of a driving-force transmission member, at the rear end thereof.

A stirring auger 17, serving as an example of a second transport member, is disposed in the stirring chamber 7. The stirring auger 17 includes a rotation shaft 17a, a transport blade 17b, and a gear G2, similarly to the supply auger 16. The gears G0 to G2 mesh with one another.

Furthermore, in FIG. 4, the stirring chamber 7 is provided with a supply port 7a at the rear part thereof, through which the developer from the cartridge Ky is supplied.

Function of Developing Device

In the thus-configured developing devices Gy to Gk, when an image forming operation is started, the motor is driven, rotating the augers 16 and 17 and the developing rollers R0y to R0k. In the first exemplary embodiment, when the supply auger 16 rotates, the supply auger 16 transports, while stirring, the developer in the supply chamber 6 from the first inflow portion 8a to the second inflow portion 8b, as indicated by an arrow Ya. The developer transported to the second inflow portion 8b flows into the stirring chamber 7 through the second inflow portion 8b. When the stirring auger 17 rotates, the stirring auger 17 transports, while stirring, the developer in the stirring chamber 7 from the second inflow portion 8b to the first inflow portion 8a, as indicated by an arrow Yb. The developer transported to the first inflow portion 8a flows into the supply chamber 6 through the first inflow portion 8a. In this manner, the supply chamber 6 and the stirring chamber 7 together constitute a circulation chamber 6+7.

The developer in the supply chamber 6 is attracted to the developing sleeve 12 due to the magnetic force of the pick-up magnetic pole S3. The developer attracted to the developing sleeve 12 passes through the trimmer 13. At this time, only a predetermined amount of developer corresponding to the space between the trimmer 13 and the developing sleeve 12 passes. After passing through the trimmer 13, the developer develops latent images on the photoconductor drums PRy to PRk, in the developing areas Q2y to Q2k. The developer that is not used to develop the latent images is kept attracted to the surface of the developing sleeve 12 as an effect of the magnetic field between the developing magnetic pole S1 and the transport magnetic pole N1 and the magnetic field between the transport magnetic pole N1 and the pick-off magnetic pole S2 and is transported. A magnetic force that attracts the developer to the developing sleeve 12 is weak between the pick-off magnetic pole S2 and the pick-up magnetic pole S3, which have the same polarity. Hence, the developer attracted to the surface of the developing sleeve 12 is detached from the developing sleeve 12 at a position between the pick-off magnetic pole S2 and the pick-up magnetic pole S3 and is returned to the circulation chamber 6+7.

Developing Sleeve

In the developing sleeve 12 according to the first exemplary embodiment, shot blasting is performed on the surface of the metal cylinder to form projections and recesses.

In the first exemplary embodiment, projections and recesses are formed so as to satisfy

y≧1.875×x+11.25 Expression (1),

where y is the average depth of the projections and recesses when the lowest position of the recesses in the projections and recesses formed in the surface of the developing sleeve 12 is assumed to be 0 and the highest position of the projections is assumed to be 100, and x is a ten-point average roughness of the projections and recesses.

Hereinbelow, the above “y” will be referred to as “duty”, and the “x” will be referred to as “roughness Rz”.

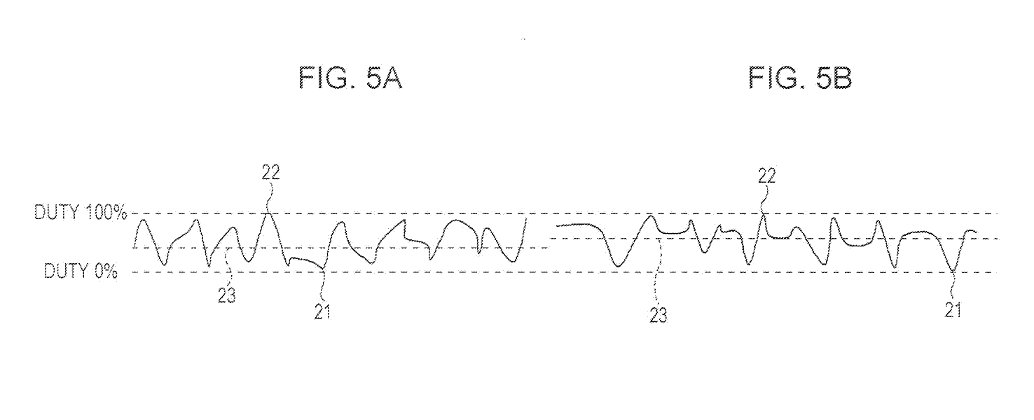

FIGS. 5A and 5B are diagrams for explaining the projections and recesses in the surface of the developing sleeve according to the exemplary embodiment, wherein FIG. 5A shows a case where duty is small, and FIG. 5B shows a case where duty is large.

As shown in FIGS. 5A and 5B, even when the lowest positions 21 and highest positions 22 of the projections and recesses are the same, the average depths of the projections and recesses may differ. That is, the average depth 23 may vary depending on the conditions, such as the hardness and collision speed of a blasting material blasted in shot blasting, the hardness of the developing sleeve 12, etc. For example, when shot blasting is performed on a developing sleeve 12 that is made of aluminum, the surface condition as shown in FIG. 5A results, and when shot blasting is performed on a developing sleeve 12 made of stainless steel (SUS), the surface condition as shown in FIG. 5B results. In the first exemplary embodiment, the average depth 23 is regarded as duty, and the value [%] of the position of the average depth 23 when the deep position 21 is assumed to be 0%, and the high position 22 is assumed to be 100% will be described as the value of duty.

As is understood from the above description, duty 100% equals Rz=0.

In the thus-configured developing devices Gy to Gk according to the first exemplary embodiment, projections and recesses are formed on the surfaces of the developing sleeves 12 by blasting. If the projections and recesses are not formed on the surfaces of the developing sleeves 12, the developer slides over the surfaces of the developing sleeves 12 when the developing sleeves rotate and is not stably transported to the developing areas Q2y to Q2k. Hence, conventionally, projections and recesses have been formed on the surfaces of the developing sleeves 12 by forming V-shaped grooves, by performing blasting, or by performing etching.

Image forming apparatuses these days use developer having a small particle diameter to improve the image quality and to reduce the cost of use (i.e., running cost). In addition, the number of sheets printed per unit time is increasing. The developer having a small particle diameter is more likely to slide over and fall off the surface of the developing sleeve 12 than the conventional developer. Furthermore, when the developing sleeve 12 rotates at high speed, the developer tends to fall off due to the centrifugal force. Moreover, when the developing sleeve 12 rotates at high speed, the time taken to pass through the developing areas Q2y to Q2k is reduced, making unevenness of the developer carried on the surface of the developing sleeve 12 more apparent and reducing the time for which an electric field acts, and consequently, decreasing the development capability.

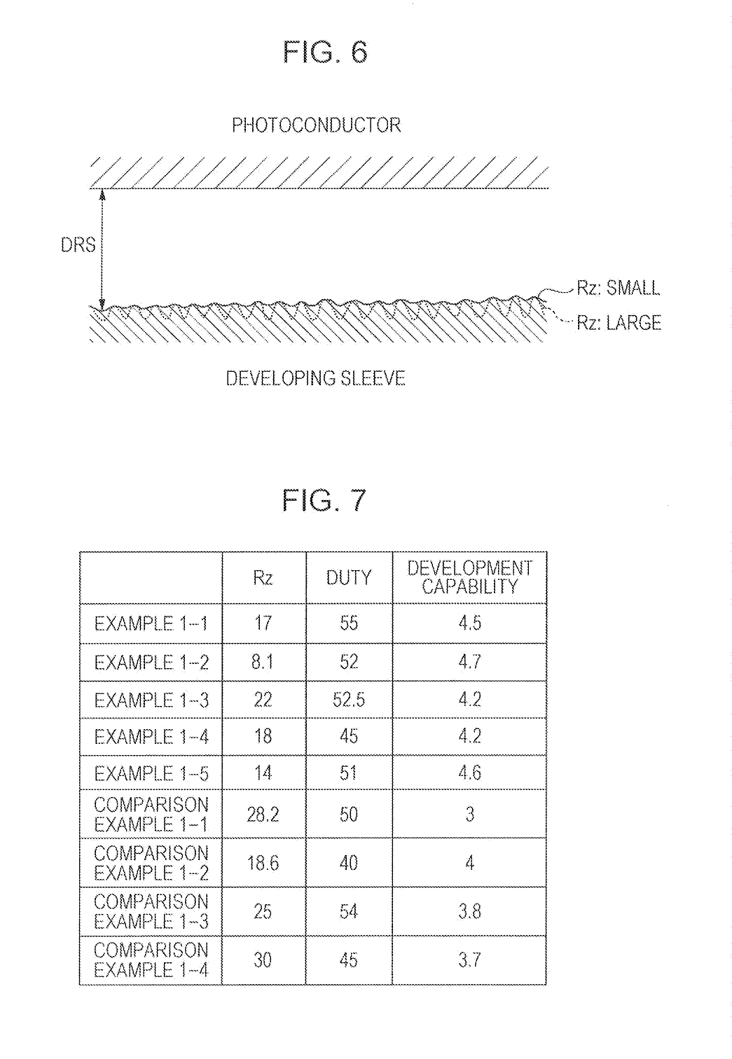

FIG. 6 shows a gap between the photoconductor and the surface of the developing roller.

In FIG. 6, the distance between the photoconductor drums PRy to PRk and the developing sleeve 12, i.e., a so-called drum to roll space (DRS), is set within a space between the surface of the photoconductor drums PRy to PRk and the surface of the developing sleeve 12, i.e., the highest position 22 of the projections and recesses. When Rz is large, the difference in level between the highest position 22 and the lowest position 21 of the projections and recesses is large. Hence, when the DRS is constant, the distance, DRS, between the highest position 22 and the photoconductor drums PRy to PRk is constant, independently of the value of Rz; however, the distance between the lowest position 21 and the photoconductor drums PRy to PRk increases with increasing Rz. Accordingly, when Rz is large, the electric field in the developing areas Q2y to Q2k is weaker in the lowest position 21 than in the highest position 22, deteriorating the development capability.

In contrast, in the developing sleeve 12 according to the first exemplary embodiment, the projections and recesses formed in the surface satisfy Expression (1). Hence, the developing sleeve 12 that satisfies Expression (1) has a high duty and a relatively small roughness Rz. Because Rz is small, the electric field is less likely to be weakened at the lowest position 21, and because duty, i.e., the average depth 23, is high (shallow), the overall electric field is less likely to be weakened. Accordingly, the development capability is higher than that in the conventional configuration.

In particular, in the developing sleeve 12 according to the first exemplary embodiment, the projections and recesses in the surface are formed by blasting, not by V-groove machining. In V-groove machining, the period of appearance of the projections and recesses in the circumferential direction is larger than that in blasting. Thus, periodic unevenness of the developer transported to the developing areas Q2y to Q2k tends to occur, corresponding to the period of the grooves. In contrast, in the first exemplary embodiment, in which blasting is performed, the period is smaller than that in a case where V-groove machining is performed. Thus, periodic unevenness of the developer transported to the developing areas Q2y to Q2k is reduced.

To confirm the effect of the first exemplary embodiment, experiments are performed.

### Example 1

In Example 1, the relationships among Rz, duty, and the development capability are observed.

Example 1 is conducted by using a modified Color 1000 Press, manufactured by Fuji Xerox Co., Ltd. In Example 1, toner having a volume average particle size of 3.8 μm is used.

The development capability is determined on the basis of so-called development mass per area (DMA), which is the amount of toner per unit area transferred to the surfaces of the photoconductor drums PRy to PRk when an image having an intensity of 100% is printed.

FIG. 7 is a table of Examples and Comparison Examples.

In Example 1-1, a developing sleeve 12 that is made of SUS is used. Rz is 17 [μm], and duty is set to 55 [%].

In Example 1-2, a developing sleeve 12 that is made of SUS is used. Rz is 8.1 [μm], and duty is set to 52 [%].

In Example 1-3, a developing sleeve 12 that is made of aluminum is used. Rz is 22 [μm], and duty is set to 52.5 [%].

In Example 1-4, a developing sleeve 12 that is made of aluminum is used. Rz is 18 [μm], and duty is set to 45 [%].

In Example 1-5, a developing sleeve 12 that is made of aluminum is used. Rz is 14 [μm], and duty is set to 51 [%].

In Comparison Example 1-1, a developing sleeve 12 that is made of SUS is used. Rz is 28.2 [μm], and duty is set to 50 [%].

In Comparison Example 1-2, a developing sleeve 12 that is made of aluminum is used. Rz is 18.6 [μm], and duty is set to 40 [%].

In Comparison Example 1-3, a developing sleeve 12 that is made of aluminum is used. Rz is 25 [μm], and duty is set to 54 [%].

In Comparison Example 1-4, a developing sleeve 12 that is made of aluminum is used. Rz is 30 [μm], and duty is set to 45 [%].

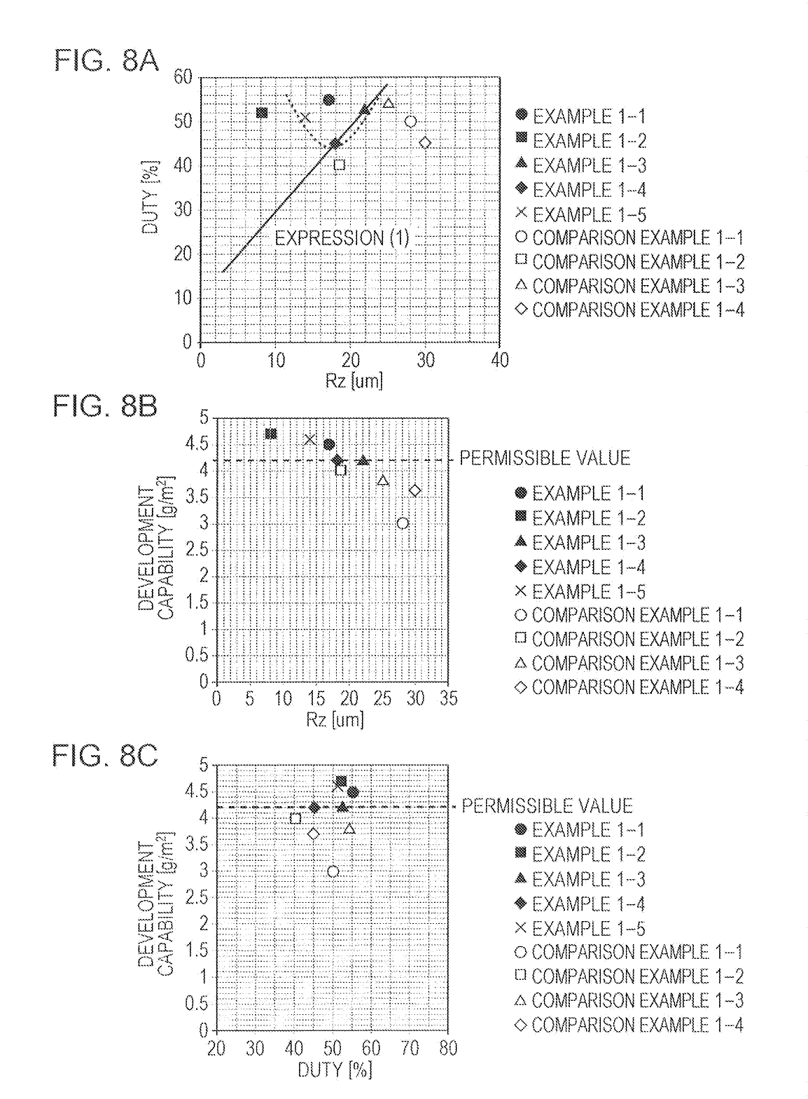

Results of the experiments are shown in FIGS. 8A to 8C.

FIGS. 8A to 8C show the results of the experiments, wherein FIG. 8A is a graph in which Rz is plotted on the horizontal axis, and duty is plotted on the vertical axis; FIG. 8B is a graph in which Rz is plotted on the horizontal axis, and the development capability is plotted on the vertical axis; and FIG. 8C is a graph in which duty is plotted on the horizontal axis, and the development capability is plotted on the vertical axis.

In FIGS. 8B and 8C, the permissible value of the development capability is 4.2 [g/m²] or more. If DMA is lower than 4.2, the intensity is low, resulting in a problem of a large color difference between a scanned image and a printed image.

FIG. 8A shows that Examples 1-1 to 1-5 are within an area satisfying Expression (1), and Comparison Examples 1-1 to 1-4 are within an area not satisfying Expression (1).

Note that the toner used in Example 1, having a volume average particle size of 3.8 μm, is toner F and toner G that are prepared as explained below.

### Example 2

In Example 2, the same experiment as in Example 1 is performed, using five types of toner, namely, toner A to toner E. As a result, it is confirmed that the developing roller 12 that satisfies Expression (1) exhibits satisfactory development capability with toners having a volume average particle size of from 3.5 μm to 5.2 μm, similarly to the development capability with a toner having a volume average particle size of 3.8 μm.

Preparation of Toner

### Synthesis of Polyester Resin

### Preparation of Amorphous Polyester Resin A

10 molar parts of bisphenol-A ethylene oxide (BPA-EO), 90 molar parts of bisphenol-A propylene oxide (BPA-PO), 95 molar parts of terephthalic acid (TPA), 5 molar parts of n-dodecenyl succinate (DSA), and 0.1 molar part of dibutyltin oxide are put into a heat-dried two-necked flask. Nitrogen gas is supplied to the flask to maintain the inside of the container under an inert atmosphere and the temperature is increased. Then, a co-condensation polymerization reaction is conducted for from 12 hours to 20 hours at from 150° C. to 230° C., and then the pressure is gradually reduced at from 210° C. to 250° C., thereby synthesizing an amorphous polyester resin A having a weight average molecular weight of 10,000 and a Tg of 62° C.

### Preparation of Crystalline Polyester Resin A

45 molar parts of 1,9-nonanediol, 55 molar parts of dodecane dicarboxylic acid, and 0.05 molar parts of dibutyltin oxide are put into a heat-dried three-necked flask. Thereafter, nitrogen gas is supplied to the flask to maintain the inside of the container under an inert atmosphere and the temperature is increased. Then, a co-condensation polymerization reaction is conducted for 2 hours at from 150° C. to 230° C., and then the temperature is gradually increased to 230° C. and stirring is performed for 10 hours. When the resultant material becomes viscous, air-cooling is performed to stop the reaction, thereby synthesizing a crystalline polyester resin A having a molecular weight of 10,000 and a melting temperature of 75° C.

### Preparation of Amorphous Polyester Resin Particle Dispersion A

3000 parts by weight of the obtained amorphous polyester resin A, 10000 parts by weight of ion exchange water, and 90 parts by weight of sodium dodecylbenzenesulfonate are put into an emulsification tank of a high-temperature and high-pressure emulsifier (Cavitron CD1010). Thereafter, these materials are melted by heating at 130° C., and then dispersed for 30 minutes at 10000 rpm, a flow rate of 3 L/m, and 110° C. and allowed to pass through a cooling tank. Whereby, an amorphous polyester resin particle dispersion A having a solid content of 30% is prepared.

### Preparation of Amorphous Polyester Resin Particle Dispersion S1

80 molar parts of bisphenol-A propylene oxide, 20 molar parts of bisphenol-A ethylene oxide, 40 molar parts of terephthalic acid, 40 molar parts of fumaric acid, 20 molar parts of n-dodecenyl succinate, and 0.1 molar part of dibutyltin oxide are put into a heat-dried reaction container. Nitrogen gas is supplied to the container to maintain the inside of the container under an inert atmosphere and the temperature is increased. Then, a co-condensation polymerization reaction is conducted for from 12 hours to 20 hours at from 150° C. to 230° C., and then the pressure is gradually reduced at from 210° C. to 250° C., thereby synthesizing an amorphous polyester resin S1 having an ethylenically unsaturated double bond, having a weight average molecular weight of 25,000 and a Tg of 60° C.

3000 parts by weight of the obtained amorphous polyester resin S1 having an ethylenically unsaturated double bond, 10000 parts by weight of ion exchange water, and 90 parts by weight of sodium dodecylbenzenesulfonate are put into an emulsification tank of a high-temperature and high-pressure emulsifier (Cavitron CD1010). Thereafter, these materials are melted by heating at 130° C., and then dispersed for 30 minutes at 10000 rpm, a flow rate of 3 L/m, and 110° C. and allowed to pass through a cooling tank. Whereby, an amorphous polyester resin particle dispersion S1 having a solid content of 30% and a volume average particle size D50v of 140 nm is prepared.

### Preparation of Colorant Dispersion

45 parts by weight of carbon black (Regal 330, prepared by Cabot Corporation), 5 parts by weight of an ionic surfactant Neogen R (Dai-ichi Kogyo Seiyaku Co., Ltd.), and 200 parts by weight of ion exchange water are mixed and dissolved, and dispersed for 10 minutes by a homogenizer (IKA-Werke GmbH & Co. KG, Ultra Turrax). Next, a dispersion treatment is performed using an ultimizer, thereby obtaining a colorant dispersion having a solid content of 20%.

### Preparation of Release Agent Dispersion

45 parts by weight of paraffin wax (HNP 0190, prepared by Nippon Seiro Co., Ltd.,), 5 parts by weight of an ionic surfactant Neogen R (prepared by Dai-ichi Kogyo Seiyaku Co., Ltd.), and 200 parts by weight of ion exchange water are heated to 120° C. and subjected to a dispersion treatment by a pressure discharge-type Gaulin homogenizer, thereby obtaining a release agent dispersion having a solid content of 20%.

### Preparation of Toner Particles

### Preparation of Toner Particles A

1170 parts by weight of an amorphous polyester resin particle dispersion A, 125 parts by weight of a colorant dispersion, 250 parts by weight of a release agent dispersion, 1.7 parts by weight of aluminum sulfate (prepared by Wako Pure Chemical Industries, Ltd.), 0.5 part by weight of sodium dodecylbenzenesulfonate, 50 parts by weight of a 0.3 M nitric acid aqueous solution, and 500 parts by weight of ion exchange water are put in a round stainless-steel flask and dispersed using a homogenizer. Then, the resultant material is heated to 50° C. in an oil bath for heating while being stirred. The resultant material is held at 50° C. And after confirmation of the formation of aggregated particles having a volume average particle size of 5.2 μm, 250 parts by weight of an additional amorphous polyester resin particle dispersion S1 is added, and then the resultant material is held for 30 minutes. Next, 1 N aqueous sodium hydroxide solution is added thereto until the pH reaches 8.5. Thereafter, the resultant material is heated to 80° C. while being stirred, and is then held for three hours.

This dispersion is filtered, and the particles remaining on the filter paper are stirred with 500 parts by weight of deionized water so as to be re-dispersed. The resultant material is further filtered so as to be washed, and then dried by a freeze dryer, thereby obtaining toner particles A.

### Preparation of Toner A

1.7 parts by weight of hydrophobic silica (RY50, prepared by Nippon Aerosil Co., Ltd.,) and 1.0 part by weight of hydrophobic titanium oxide (T805, prepared by Nippon Aerosil Co., Ltd.,) are added to 50 parts by weight of the toner particles A and blended using a Henschel mixer to obtain a toner A.

### Preparation of Toner Particles B

Toner particles B are obtained in the same manner as in the preparation of the toner particles A, except that the amount of aluminum sulfate to be added is changed to 1.2 parts by weight.

### Preparation of Toner B

Toner B is obtained in the same manner as in the preparation of the toner particles A, except that the amount of hydrophobic silica is changed to 2.4 parts by weight and that the amount of hydrophobic titanium oxide is changed to 1.6 parts by weight.

### Preparation of Toner C

Toner C is obtained in the same manner as in the preparation of the toner particles A, except that the amount of hydrophobic silica is changed to 1.2 parts by weight and that the amount of hydrophobic titanium oxide is changed to 0.7 parts by weight.

### Preparation of Toner Particles D

Toner particles D are obtained in the same manner as in the preparation of the toner particles A, except that the amount of aluminum sulfate to be added is changed to 2.3 parts by weight.

### Preparation of Toner D

Toner D is obtained in the same manner as in the preparation of the toner particles A, except that the amount of hydrophobic silica is changed to 1.6 parts by weight and that the amount of hydrophobic titanium oxide is changed to 1.1 parts by weight.

### Preparation of Toner E

Toner E is obtained in the same manner as in the preparation of the toner particles A, except that the amount of hydrophobic silica is changed to 0.8 parts by weight and that the amount of hydrophobic titanium oxide is changed to 0.5 parts by weight.

### Preparation of Toner Particles F

Toner particles F are obtained in the same manner as in the preparation of the toner particles A, except that the amount of aluminum sulfate to be added is changed to 1.3 parts by weight.

### Preparation of Toner F

Toner F is obtained in the same manner as in the preparation of the toner particles A, except that the amount of hydrophobic silica is changed to 2.2 parts by weight and that the amount of hydrophobic titanium oxide is changed to 1.5 parts by weight.

### Preparation of Toner G

Toner G is obtained in the same manner as in the preparation of the toner particles A, except that the amount of hydrophobic silica is changed to 1.1 parts by weight and that the amount of hydrophobic titanium oxide is changed to 0.6 parts by weight.

TABLE 1

| | Volume Average | Compression |
|---|---|---|
| | Particle Size | Ratio |
| Toner A | 4.4 μm | 0.36 |
| Toner B | 3.5 μm | 0.30 |
| Toner C | 3.5 μm | 0.42 |
| Toner D | 5.2 μm | 0.30 |
| Toner E | 5.2 μm | 0.42 |
| Toner F | 3.8 μm | 0.30 |
| Toner G | 3.8 μm | 0.42 |

Modification

Although the exemplary embodiments of the present invention have been described in detail above, the present invention is not limited to such exemplary embodiments, and they may be variously modified within a scope of the present invention. Modifications (H01) to (H03) of the present invention will be described below.

(H01) In the above-described exemplary embodiments, a copier is shown as an example of the image forming apparatus. However, the image forming apparatus is not limited to the copier, but may be, for example, a printer, a facsimile, or a multi-function machine having some of or all of these functions.
(H02) In the exemplary embodiment, the copier U uses four color developers. However, the copier U may be applicable to, for example, a single-color image forming apparatus or a multi-color image forming apparatus that uses more than or less than four colors.
(H03) In the exemplary embodiment, the number of the magnetic poles of the magnet roller 11 is not limited to five. For example, a magnet roller that has an odd number, such as three or seven or more, of magnetic poles may also be employed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A developing device comprising:
a container in which developer is contained; and
a developer carrier disposed in the container, the developer carrier including a magnet member having a plurality of magnetic poles and including a rotation member that covers an outer circumference of the magnet member and is supported in a rotatable manner, the developer carrier developing a latent image formed on an image carrier into a visible image with the developer held on a surface of the rotation member as an effect of the magnet member,
wherein the rotation member has projections and recesses formed in the surface, the projections and recesses satisfying
y≧1.875/μm×x+11.25 Expression (1),
where y is an average depth of the projections and recesses when a lowest position of the recesses is assumed to be 0% and a highest position of the projections is assumed to be 100%, and x is a ten-point average roughness of the projections and recesses in μm,
wherein x is limited to a range between 0 to 47.33 μm.

2. The developing device according to claim 1, wherein the projections and recesses in the rotation member are formed by performing blasting on a cylindrical surface thereof.

3. An image forming apparatus comprising:
the image carrier;
a latent-image forming device that forms the latent image on a surface of the image carrier;
the developing device according to claim 1, the developing device developing the latent image on the surface of the image carrier into a visible image;
a transfer device that transfers the visible image on the surface of the image carrier to a medium; and
a fixing device that fixes the visible image onto the surface of the medium.
